(19) United States
(12) Patent Application Publication
(10) Pub. No.: US 2009/0161260 A1
(43) Pub. Date: Jun. 25, 2009

(54) STORAGE APPARATUS AND RETRACTION MECHANISM FOR HEAD ACTUATOR THEREOF

(75) Inventor: Yoshihiko NAKAMURA, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/340,721

(22) Filed: Dec. 21, 2008

(30) Foreign Application Priority Data
Dec. 21, 2007 (JP) 2007-330733

(51) Int. Cl. G11B 5/54

(52) U.S. Cl. 360/256.2; G9B/5.181

(57) ABSTRACT

A retraction mechanism for a head actuator having a head at the end thereof includes a metal piece that is attached to a coil arm, a stopper, and a magnet. The metal piece is configured to be attracted to the stopper with a magnetic force exerted by the magnet to retract the head outside the outer periphery of a storage medium. The metal piece is attached in contact with a surface of the coil arm other than the one facing the stopper.

### BACKGROUND OF THE INVENTION

1. Field of the Invention

The present invention relates to a storage apparatus that includes a head actuator with a retraction mechanism, and the retraction mechanism for the head actuator.

2. Description of the Related Art

Storage apparatuses such as magnetic disk apparatuses include a head actuator having a head attached thereto at the end by a head slider. The head actuator moves the head to a target track on a disk storage medium such as a magnetic disk to read and write data from and to the storage medium. The head actuator is swingably supported on a rotation axis so that a moving range of the head is in a circular arc whose chord is the radius of the storage medium. In the head actuator, at a portion in a reverse direction from the head that moves about the rotation axis is a voice coil motor (VCM) coil that applies a swinging force to the head actuator.

The storage medium rotates about the rotation axis of a motor, i.e., the center of the disk. When the storage medium is rotated, the head can maintain height at a certain distance from the storage medium, by the lift force of the head slider. However, when the storage medium is not rotated, the head comes into contact with a surface of the storage medium, because the head slider cannot be lifted. If the head comes into contact with the surface of the storage medium, and when an impact is applied to the storage apparatus, the head may scratch the surface of the storage medium, thereby eliminating data stored in the storage medium.

To prevent such a situation, in general, a mechanism called a magnetic catch has been used. The magnetic catch retracts the head outside an outer periphery of the storage medium, by fixing a metal piece at a side of the VCM coil of the head actuator block, and by making a stopper made of resin embedded with a magnet attract the metal piece. With this mechanism, an accurate position of the stopper and high retraction torque can be obtained. However, because the retraction torque decreases rapidly with distance from the retracted position, the head actuator may swing unintentionally.

The maximum value of the retraction torque needs to be increased, to prevent the unintentional swing of the head actuator. However, when the retraction torque is reduced by limiting the magnetic flux density of the VCM and by limiting the current that can be supplied to the VCM coil, it was impossible to obtain stable retraction torque in a wide range.

For example, as disclosed in Japanese Patent Application Laid-open No. 2005-243149, a retraction mechanism for a head actuator of a storage apparatus has been proposed that retracts a head outside a circular storage medium. Trough the retraction mechanism, when a storage medium is not rotating, a metal piece arranged at a part of the VCM coil of the head actuator is attracted to a main magnet of the VCM, and thus one side of the VCM coil is moved to the position of a stopper made of resin with stable retraction torque in a wide range.

To retract the head actuator and hold it at the position of the stopper with high accuracy and high retraction torque, a contact position between the head actuator and the stopper, and a generation position of the retraction torque are preferably placed as far as possible from the rotation axis of the actuator. However, in the related art represented by the Japanese Patent Application Laid-open No. 2005-243149, because of the interference by the main magnet and the stopper, the contact position with the stopper and the generation position of the retraction torque could not be set around an end of the VCM coil of the head actuator (i.e., the farthest portion from the rotation axis). Moreover, it was difficult to obtain stable and high retraction torque at the position of the stopper.

### SUMMARY

It is an object of the present invention to at least partially solve the problems in the conventional technology.

According to an aspect of the present invention, there is provided a storage apparatus includes: a head actuator that is swingably supported on a rotation axis, and includes an arm that has a first end and a second end; a head that is attached to the first end of the arm for reading and writing data from and to a storage medium; a metal piece that is attached to a tip extending from a metal portion at an edge of a coil on the second end of the arm; a stopper; a magnetic circuit that includes a magnet for generating a magnetic field that provides a driving force to swing the coil being electrically energized; and a retraction mechanism for the head actuator that retracts the head outside an outer periphery of the storage medium by attracting the metal piece to the stopper with a magnetic force exerted by the magnet. The tip has an opposing surface facing the stopper, and the metal piece is attached in contact with a surface of the tip other than the opposing surface.

According to another aspect of the present invention, there is provided a retraction mechanism for a head actuator that is swingably supported on a rotation axis and includes an arm that has a first end and a second end. A head is attached to the first end for reading and writing data from and to a storage medium. The retraction mechanism includes: a metal piece that is attached to a tip extending from a metal portion at an edge of a coil on the second end of the arm; a stopper; a magnetic circuit that includes a magnet for generating a magnetic field that provides a driving force to swing the coil being electrically energized. The metal piece is configured to be attracted to the stopper with a magnetic force exerted by the magnet to retract the head outside an outer periphery of the storage medium. The tip has an opposing surface facing the stopper, and the metal piece is attached in contact with a surface of the tip other than the opposing surface.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a top-view of a magnetic disk apparatus;

FIG. 2 is an enlarged view of the surrounding area of where a retraction mechanism of the magnetic disk apparatus is arranged;

FIG. 3 is an enlarged view of an actuator provided on the magnetic disk apparatus;

FIG. 4 is an enlarged view of a first example of a conventional retraction mechanism;

FIG. 5 is an enlarged view of a second example of a conventional retraction mechanism;

FIG. 6 is an enlarged view of a retraction mechanism according to an embodiment of the present invention;

FIG. 7 is a comparison chart of characteristics of retraction torques of the retraction mechanisms;

FIG. 8 is an enlarged view of a retraction mechanism according to a first modification of the embodiment;

FIG. 9 is an enlarged view of a retraction mechanism according to a second modification of the embodiment; and

FIG. 10 is an enlarged view of a retraction mechanism according to a third modification of the embodiment.

### DETAILED DESCRIPTION OF THE PREFERRED EMBODIMENTS

Exemplary embodiments of the present invention are explained in detail below with reference to the accompanying drawings.. In the following, a magnetic disk is described as a storage medium, and a magnetic disk apparatus is described as a storage apparatus. However, the present invention is applicable to any storage apparatus that includes a head actuator with a retraction mechanism swingably supported on a rotation axis, or more specifically, a head actuator having an arm one end of which is attached with a head that reads and writes data from and to a storage medium, and the other end is attached with a metal piece at the tip extended therefrom, and retracting the head outside the outer periphery of the storage medium by attracting the metal piece by a magnet embedded in a stopper.

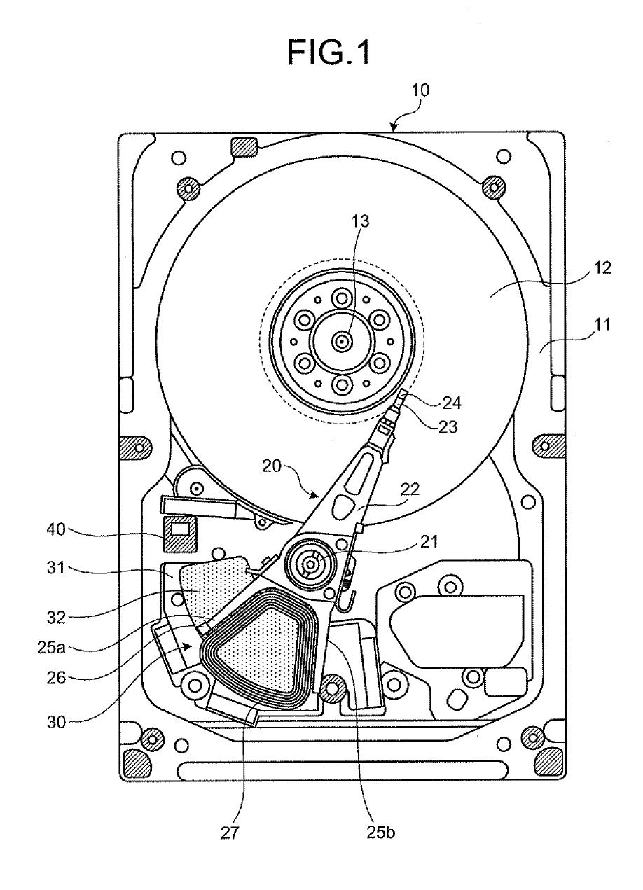

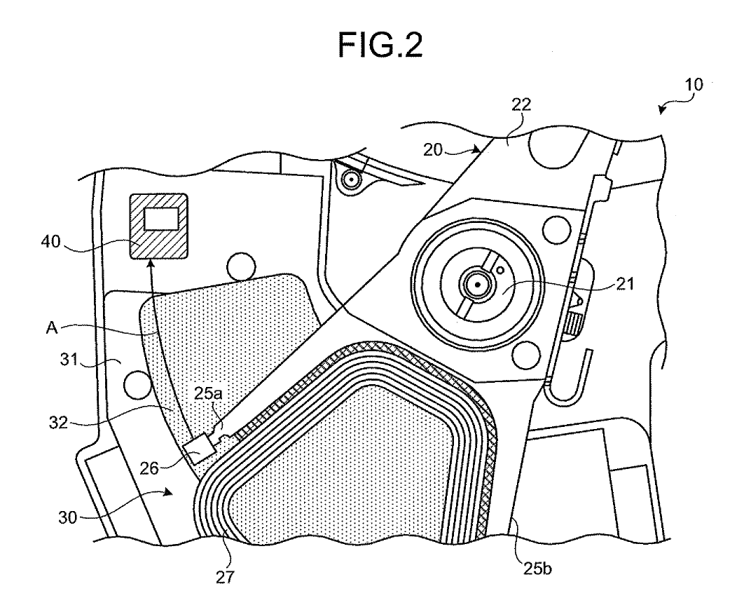

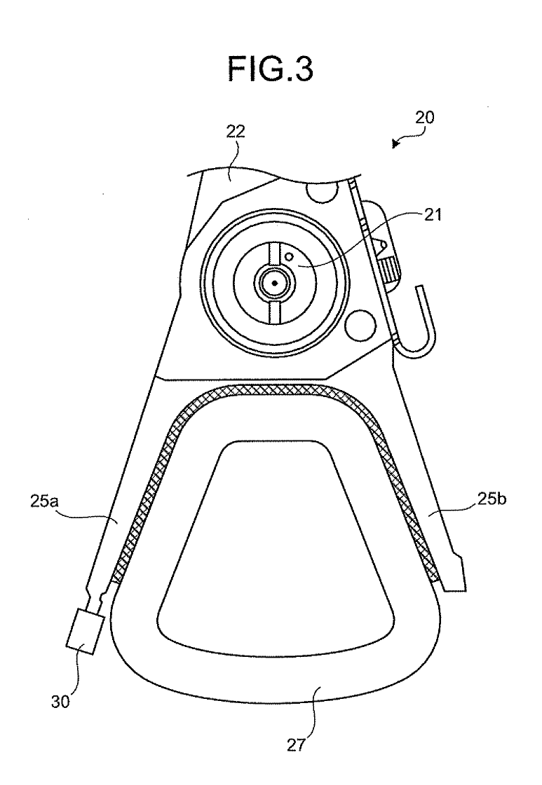

A configuration of a magnetic disk apparatus is schematically described below. FIG. 1 is a top-view of a magnetic disk apparatus 10. FIG. 2 is an enlarged view of the surrounding area of where a retraction mechanism of the magnetic disk apparatus 10 is arranged. FIG. 3 is an enlarged view of an actuator (hereinafter, “head actuator”) of the magnetic disk apparatus 10.

FIGS. 1 and 2 depicts the magnetic disk apparatus 10 without a top lid thereof, and a top lid, an upper yoke material and an upper magnet of a VCM 30 to show the internal structure of a base casing 11 of the magnetic disk apparatus 10 and a VCM coil 27 of the head actuator are being visible.

As shown in FIG. 1, in the magnetic disk apparatus 10, the center of the a magnetic disk 12 is fixed to a rotation axis of a spindle motor (not shown) by a disk fixing mechanism 13. The magnetic disk 12 rotates with the rotation of the spindle motor.

In the magnetic disk apparatus 10, an actuator 20 that supports a head slider 24 mounted with a magnetic head is swingably supported on a rotation axis 21. At the side of the magnetic disk 12 relative to the rotation axis 21 of the actuator 20, the head slider 24 is provided via a support arm 22 and a support spring 23.

As shown in FIGS. 1, 2, and 3, in the magnetic disk apparatus 10, the VCM coil 27, and a coil arm 25a and a coil arm 25b that support the VCM coil 27 are provided at a side opposite the magnetic disk 12 with respect to the rotation axis 21 of the actuator 20. The coil arm 25a and the coil arm 25b are made of aluminum because of easy fabrication and light weight.

At the end of the coil arm 25a, a metal piece 26 that forms the retraction mechanism for the actuator 20 is fixed by an adhesive or by caulking of the metal piece 26. The metal piece 26, as well as a metal piece 26a, a metal piece 26b, a metal piece 26c, and a metal piece 26d, described later, are made of cold-rolled steel plate/sheet (SPCC).

In the magnetic disc apparatus 10, the VCM 30 includes a base casing (not shown), in which a lower yoke material 31, a lower magnet 32 adhered on an upper surface of the lower yoke material 31, an upper magnet (not shown), an upper yoke material (not shown), to which the upper magnet is adhered at the lower surface, a dumper (not shown), and a cover (not shown) are sequentially mounted from bottom to top. The yoke material is a kind of a magnetic body.

The VCM coil 27 is inserted into a space between the upper magnet and the lower magnet 32, so as to maintain a certain distance between the upper magnet and the lower magnet 32. The VCM coil 27 swings about the rotation axis 21, by being electrically energized, in a magnetic field of the upper magnet and the lower magnet 32.

The magnetic disk apparatus 10 includes a stopper 40 made of resin that, when the magnetic disk 12 is not rotated, retracts the head slider 24 outside an outer periphery of the magnetic disk 12, and also prevents the head slider 24 from retracting excessively outside the outer periphery of the magnetic disk 12. The stopper 40 contains a magnet (not shown).

When the magnetic disk 12 is not rotated, the retraction mechanism for the actuator 20 that retracts the head slider 24 outside the outer periphery of the magnetic disk 12 operates, because the metal piece 26 fixed to the end of the coil arm 25a of the actuator 20 is attracted by a magnetic force of the magnet contained in the stopper 40 in a direction indicated by an arrow A in FIG. 2.

A conventional retraction mechanisms are described below. FIG. 4 is an enlarged view of a first example of a conventional retraction mechanism (hereinafter, “first conventional example”). The first conventional example is described with reference to FIG. 4.

In the first conventional example, the end portion of the coil arm 25a of the actuator 20 has a rectangular cross section. The metal piece 26 in a bracket-shape is attached to be in contact with an upper surface of the end of the coil arm 25a, an opposing surface facing the stopper 40, and a surface opposite the opposing surface.

The stopper 40 contains a magnet 40a, and the actuator 20 is retracted because the metal piece 26 is attracted by the magnetic force of the magnet 40a. However, in the first conventional example, although retraction torque due to the magnetic force of the magnet 40a can be obtained sufficiently around the stopper 40, the retraction torque decreases rapidly with distance from the stopper 40.

Therefore, in the first conventional example, the head slider 24 may not be reliably retracted, when the head slider 24 is placed near the center of the magnetic disk 12. When a strong impact is applied to the magnetic disk apparatus 10, while the head slider 24 remains around the center of the magnetic disk 12, even if the magnetic disk apparatus 10 is not being operated, the magnetic head attached to the head slider 24 sometimes scratches the surface of the magnetic disk 12, thereby damaging data stored in the magnetic disk 12.

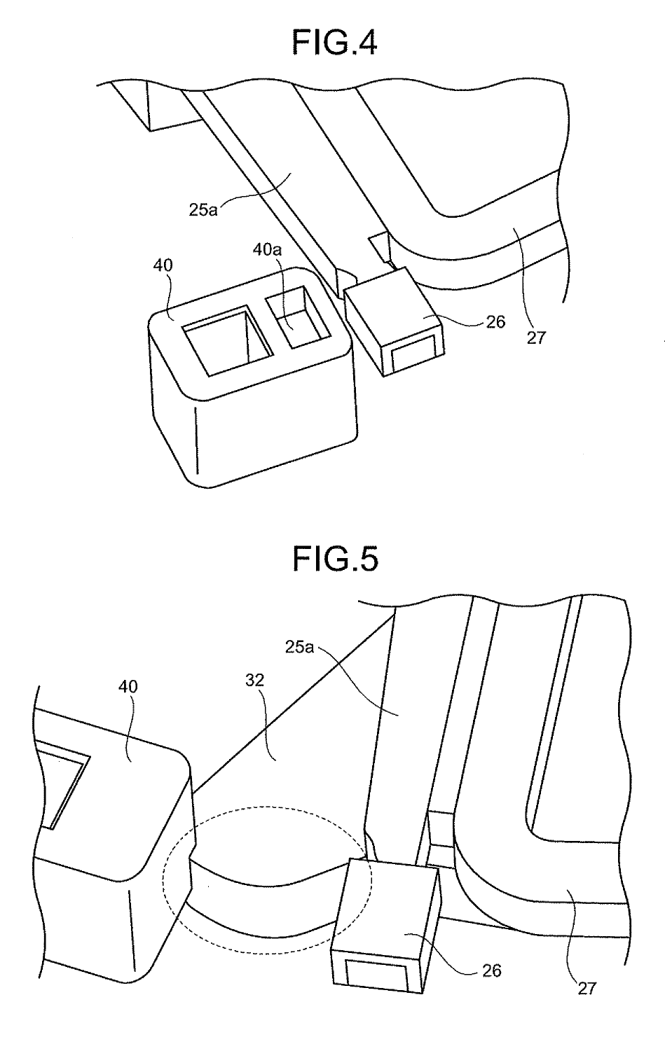

FIG. 5 is an enlarged view of a second example of a conventional retraction mechanism (hereinafter, “second conventional example”). The second conventional example is described with reference to FIG. 5. In the second conventional example, as with that of the first conventional example, the end portion of the coil arm 25a of the actuator 20 has a rectangular cross section. The metal piece 26 in a bracket-shape is attached to be in contact with the upper surface of the end of the coil arm 25a, the opposing surface facing the stopper 40, and the surface opposite the opposing surface.

The stopper 40 of the second conventional example does not contain the magnet 40a. Alternatively, the actuator 20 is retracted, because the metal piece 26 is attracted to the stopper 40 by a magnetic force of the lower magnet 32 of the VCM 30 and the upper magnet (not shown).

In the second conventional example, the lower magnet 32 and the upper magnet (not shown) need to be protruded to the outer peripheral side of the magnetic disk 12. However, because a positional interference occurs with the stopper 40 (see a broken-line circle in FIG. 5), the protrusion needs to be to the extent not to generate interference. As a result, the retraction torque cannot be obtained sufficiently around the stopper 40, because the magnetic force of the lower magnet 32 and the upper magnet (not shown) decreases.

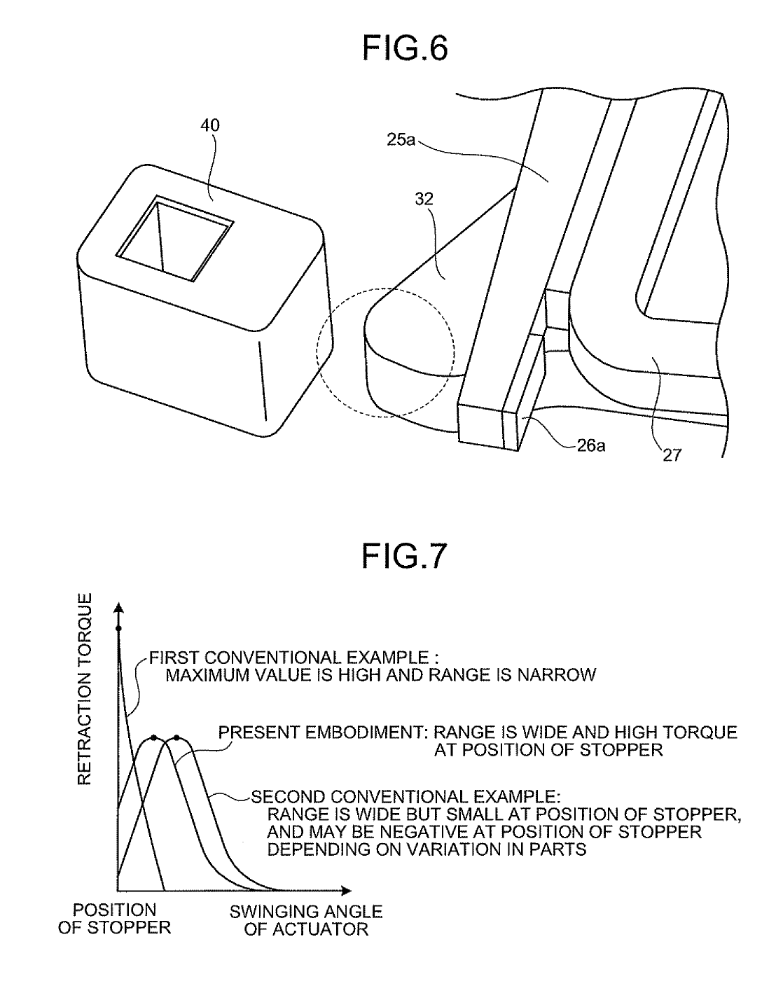

Described below is a retraction mechanism according to an embodiment of the present invention. FIG. 6 is an enlarged view of the retraction mechanism according to the present embodiment. As shown in FIG. 6, similar to that of the second conventional example, the stopper 40 does not contain the magnet 40a. The actuator 20 is retracted because the metal piece 26a is attracted to the stopper 40 by the magnetic force of the lower magnet 32 of the VCM 30 and the upper magnet (not shown). Moreover, similar to that of the second conventional example, the end portion of the coil arm 25a of the actuator 20 has a rectangular cross section.

However, the metal piece 26a in a flat shape is attached to be in contact with the surface of the coil arm 25a, opposite the opposing surface facing the stopper 40. In other words, because the metal piece 26a is attached at a position further away from the stopper 40, protruding portions of the lower magnet 32 and of the upper magnet (not shown) should be moved closer to the metal piece 26a. Accordingly, the protruding portions are moved away from the stopper 40, not generating the positional interference (see a broken-line circle in FIG. 6).

Described below is characteristics of retraction torque of the retraction mechanism. FIG. 7 is a comparison chart of characteristics of retraction torques of the retraction mechanisms. As shown in FIG. 7, in the first conventional example, the retraction torque becomes maximum at a position of the stopper 40. However, a swinging angle of the actuator 20 increases, and the retraction torque decreases rapidly, as the metal piece 26 moves away from the position of the stopper 40. Because stable retraction torque cannot be obtained over a wide range of the swinging angle of the actuator 20, the retract function may not function sufficiently.

In the second conventional example, the range reached by the retraction torque is wider compared with that of the first conventional example. However, the retraction torque is small, when the metal piece 26 is placed at the position of the stopper 40. Therefore, even if the actuator 20 is retracted, the retraction may be released, when the strong impact is applied to the magnetic disc apparatus 10. Moreover, depending on variation in parts of the metal piece 26, the retraction torque may become negative, when the metal piece 26 is placed at the position of the stopper 40.

In the present embodiment, the range reached by the retraction torque is wide, and the retraction torque is sufficient even if the metal piece 26a is placed at the position of the stopper 40. Therefore, it is possible to obtain stable retraction torque over a wide range of the swinging angle of the actuator 20. Moreover, even if the strong impact is applied to the magnetic disk apparatus 10 when the actuator 20 is being retracted, the retraction of the actuator 20 can be maintained.

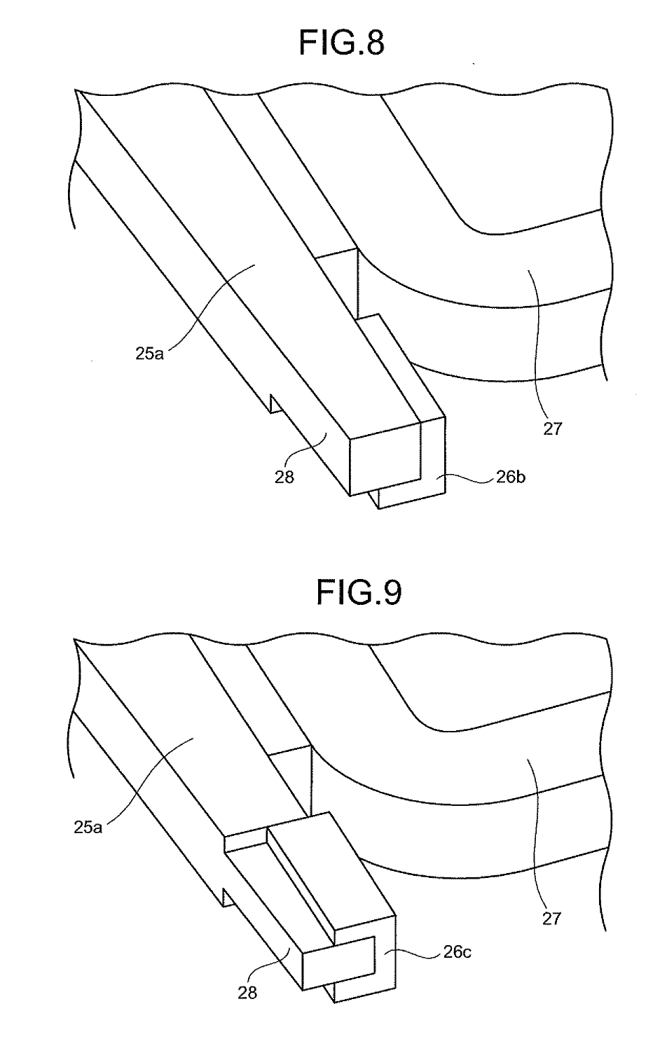

A retraction mechanism according to modifications of the embodiment is described below with reference to FIGS. 8 to 10. FIG. 8 is an enlarged view of a retraction mechanism according to a first modification of the embodiment. Similar to that of the second conventional example, the stopper 40 does not contain the magnet 40a, and the actuator 20 is retracted, because the metal piece 26b is attracted to the stopper 40 by the magnetic force of the lower magnet 32 of the VCM 30 and the upper magnet (not shown). Similar to that of the embodiment, the end portion of the coil arm 25a of the actuator 20 has a rectangular cross section.

The metal piece 26b of the first modification is in an L-shape. The metal piece 26b is attached to be in contact with the surface of the coil arm 25a, opposite an opposing surface 28 facing the stopper 40, to the half of the lower surface thereof. The lower portion of the end portion of the coil arm 25a is cut and fabricated depending on at least one of the size and shape of the metal piece 26b. This is to obtain appropriate retraction torque by adjusting at least one of the size and shape of the metal piece 26b.

FIG. 9 is an enlarged view of a retraction mechanism according to a second modification of the embodiment. Similar to that of the second conventional example, the stopper 40 does not include the magnet 40a, and the actuator 20 is retracted, because the metal piece 26c is attracted to the stopper 40 by the magnetic force of the lower magnet 32 of the VCM 30 and the upper magnet (not shown). Similar to that of the embodiment, the end portion of the coil arm 25a of the actuator 20 has a rectangular cross section.

The metal piece 26c of the second modification is in a bracket-shape. The metal piece 26c is attached to be in contact with the half of the upper surface of the coil arm 25a, to the half of the lower surface thereof, via the surface opposite the opposing surface 28 facing the stopper 40. The upper portion and the lower portion of the end portion of the coil arm 25a are cut and fabricated to match at least one of the size and shape of the metal piece 26c. This is, similar to that of the first modification, to obtain appropriate retraction torque by adjusting at least one of the size and shape of the metal piece 26c.

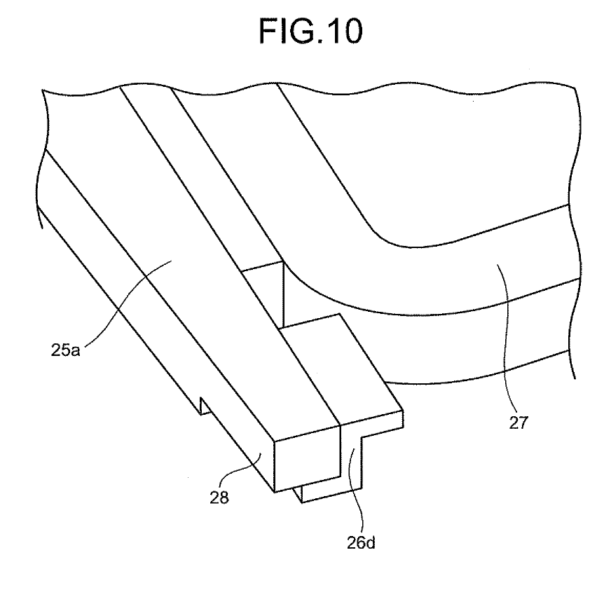

FIG. 10 is an enlarged view of a retraction mechanism according to a third modification of the embodiment. Similar to that of the second conventional example, the stopper 40 does not contain the magnet 40a, and the actuator 20 is retracted, because the metal piece 26d is attracted to the stopper 40 by the magnetic force of the lower magnet 32 of the VCM 30 and the upper magnet (not shown). Similar to that of the embodiment, the end portion of the coil arm 25a of the actuator 20 has a rectangular cross section. The metal piece 26d of the third modification is in a crank shape. The metal piece 26d is attached to be in contact with the half of the lower surface of the coil arm 25a to the surface opposite the opposing surface 28 facing the stopper 40. The metal piece 26d also has a portion that is a surface extending from the upper surface of the end portion of the coil arm 25a. The lower portion of the end portion of the coil arm 25a is cut and fabricated to match at least one of the size and shape of the metal piece 26d. This is, similar to those of the first and second modifications, to obtain appropriate retraction torque by adjusting at least one of the size and shape of the metal piece 26d.

As set forth hereinabove, according to an embodiment of the present invention, the head actuator can be retracted and held at the position of a stopper with high retraction-positioning accuracy and high retraction torque. Moreover, stable retraction torque obtained in a wide range.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A storage apparatus comprising:
a head actuator that is swingably supported on a rotation axis, and includes an arm that has a first end and a second end;
a head that is attached to the first end of the arm for reading and writing data from and to a storage medium;
a metal piece that is attached to a tip extending from a metal portion at an edge of a coil on the second end of the arm;
a stopper;
a magnetic circuit that includes a magnet for generating a magnetic field that provides a driving force to swing the coil being electrically energized; and
a retraction mechanism for the head actuator that retracts the head outside an outer periphery of the storage medium by attracting the metal piece to the stopper with a magnetic force exerted by the magnet, wherein
the tip has an opposing surface facing the stopper, and
the metal piece is attached in contact with a surface of the tip other than the opposing surface.

2. The storage apparatus according to claim 1, wherein
the tip has a rectangular cross section,
the metal piece is in a flat-plate shape, and
the surface of the tip that the metal piece is attached in contact with is opposite the opposing surface.

3. The storage apparatus according to claim 1, wherein
the tip has a rectangular cross section, and
the metal piece is in a V-shape, and
the surface of the tip that the metal piece is attached in contact with includes a surface opposite the opposing surface and a portion of a lower surface perpendicular to the opposing surface.

4. The storage apparatus according to claim 1, wherein
the tip has a rectangular cross section, and
the metal piece is in a bracket-shape, and
the surface of the tip that the metal piece is attached in contact with includes a surface opposite the opposing surface and portions of an upper surface and a lower surface perpendicular to the opposing surface.

5. The storage apparatus according to claim 1, wherein
the tip has a rectangular cross section, and
the surface of the tip that the metal piece is attached in contact with includes a surface opposite the opposing surface and a portion of a lower surface perpendicular to the opposing surface, and has a portion extending from an upper surface of the tip.

6. The storage apparatus according to claim 2, wherein a portion of the tip to be attached with the metal piece is cut and machined depending on at least one of a size and a shape of the metal piece.

7. The storage apparatus according to claim 3, wherein a portion of the tip to be attached with the metal piece is cut and machined depending on at least one of a size and a shape of the metal piece.

8. The storage apparatus according to claim 4, wherein a portion of the tip to be attached with the metal piece is cut and machined depending on at least one of a size and a shape of the metal piece.

9. The storage apparatus according to claim 5, wherein a portion of the tip to be attached with the metal piece is cut and machined depending on at least one of a size and a shape of the metal piece.

10. A retraction mechanism for a head actuator that is swingably supported on a rotation axis and includes an arm that has a first end and a second end, a head being attached to the first end for reading and writing data from and to a storage medium, the retraction mechanism comprising:
a metal piece that is attached to a tip extending from a metal portion at an edge of a coil on the second end of the arm;
a stopper;
a magnetic circuit that includes a magnet for generating a magnetic field that provides a driving force to swing the coil being electrically energized, wherein
the metal piece is configured to be attracted to the stopper with a magnetic force exerted by the magnet to retract the head outside an outer periphery of the storage medium,
the tip has an opposing surface facing the stopper, and
the metal piece is attached in contact with a surface of the tip other than the opposing surface.
